(19) United States
(12) Patent Application Publication
(10) Pub. No.: US 2026/0236745 A1
(43) Pub. Date: Aug. 13, 2026

(54) GENERALIZED LANE-WISE ADDITIVE DECOMPOSITION: A TOKEN ATTRIBUTION METHOD FOR LLM EXPLAINABILITY

(71) Applicant: Oracle International Corporation, Redwood Shores, CA (US)

(72) Inventors: Farouk Boukil, Zurich (CH); Yasha Pushak, Vancouver (CA); Ali Seyfi, Vancouver (CA); Hesam Fathi Moghadam, Sunnyvale, CA (US); Rhicheek Patra, Zurich (CH); Sungpack Hong, Palo Alto, CA (US)

(21) Appl. No.: 19/221,808

(22) Filed: May 29, 2025

Related U.S. Application Data
(60) Provisional application No. 63/757,999, filed on Feb. 13, 2025.

(51) Int. Cl. G06N 3/0455; G06N 3/0475

(52) U.S. Cl. CPC G06N 3/0455; G06N 3/0475

(57) ABSTRACT

Herein is conservation of time and space while generating a local explanation, by tracing decomposed token contributions through neural layers, to discover why a transformer language model made an inference. During a feedforward pass in the model, which contains a model sequence of multiple transformer sublayers, exactly one previous vector decomposition is transferred to a last transformer sublayer in the model from a previous transformer sublayer that is adjacent to the last transformer sublayer. From the previous vector decomposition and an input of the last transformer sublayer, the feedforward pass also generates exactly one last vector decomposition. From the last vector decomposition after the feedforward pass, a local explanation is generated for why the model inferentially generated a (e.g. sequential) output from a linguistic prompt.

### BENEFIT CLAIM

This application claims the benefit of Provisional Application 63/757,999, filed Feb. 13, 2025, the entire contents of which is hereby incorporated by reference as if fully set forth herein, under 35 U.S.C. § 119 (e).

### FIELD OF THE INVENTION

Herein is conservation of time and space while generating a local explanation, by tracing decomposed token contributions through neural layers, to discover why a transformer language model made an inference.

### BACKGROUND

Explainability methods in artificial intelligence (AI) help clarify how models make decisions by using tools such as feature attribution to trace the influence (i.e. importance) of inputs on outputs. This transparency may be crucial for ensuring safe usage of AI, particularly in critical fields. In natural language processing (NLP), feature attribution identifies the impact of individual elements such as words or phrases on a language large model (LLM)'s predictions, providing insights into the often opaque mechanisms of complex models. By assigning numerical importance values to features, these methods illuminate the reasons behind learned outputs and enhance interpretability.

Feature attribution in NLP can be achieved using various methods. Gradient-based methods define feature attributions as the sensitivity of the output to small input changes, with large gradients indicating significant importance. Gradient methods satisfy output sensitivity by design. However, the latter can suffer from technologic inaccuracies such as: i) oversensitivity to hyperparameters (e.g., the baseline input, the integration path, or the number of integration steps), ii) the vanishing or exploding gradient problem, and iii) noise due to sensitivity to small input perturbations, which can cause drastic changes in gradients. Due to the noisiness (i.e. technologic instability) of gradients, several approaches have been explored to enhance the accuracy of gradient-based methods at the cost of a longer running time because most gradient methods perform several end-to-end backward passes on the model. In practice, gradient methods are the slowest way to measure importance.

Perturbation-based methods assess the importance of input components by introducing changes to the input data and observing the effect on model outputs. One prominent approach is the Shapley values method that uses cooperative game theory to determine each feature's contribution. Shapley Additive Explanations (SHAP) provides an efficient approximation of the Shapley values, sacrificing some technologic accuracy for acceleration that is needed because perturbation-based methods can be slow. Perturbation method time complexity scales poorly because the number of required inferences scales at least quadratically to the number of input tokens, and linearly to the number of attributed output tokens.

Herein, explanation accuracy and explanation latency are technologic problems, and there is a technology design tension (i.e. tradeoff) between accuracy and acceleration. Explanation methods for opaque (i.e. black box) models are, in some ways, inherently the least accurate with insufficient time and the slowest for sufficient accuracy. The easiest way to accelerate a perturbation method is to decrease the count of perturbed samples generated. The easiest way to accelerate a gradient method is to decrease the count of noisy samples, which decreases the count of backward passes. In the state of the art, explanation acceleration decreases accuracy, and that decrease can be measured in the following ways.

Faithfulness (a.k.a. fidelity) is the most direct measure of an explanation's accuracy. Fidelity assesses how well the explanation truly reflects the internal logic and decision-making process of the machine learning model. If an explanation claims a certain feature is important, then perturbing or removing that feature should significantly impact the model's prediction. The following are fidelity quantities: Prediction Gap on Important features (PGI), Prediction Gap on Unimportant features (PGU), RemOve And Retrain (ROAR), and Permutation Importance (PI).

Stability (a.k.a. robustness) quantifies how consistent and similar the explanations are for similar inputs or for the same input with slight perturbations. If a small, irrelevant change to the input leads to a drastically different explanation, the explanation is considered unstable and less trustworthy. The following are stability quantities: Relative Input Stability (RIS), Relative Output Stability (ROS), Relative Representation Stability (RRS), Max-Sensitivity, and Separability.

### BRIEF DESCRIPTION OF THE DRAWINGS

In the drawings:

FIG. 1 is a block diagram that depicts an example computer that conserves time and space while generating a local explanation, by propagating vector decompositions upwards, to discover why a transformer model inferred an output;

FIG. 2 is a block diagram that depicts an example vector decomposition and an example language modeling head;

FIG. 3 is a legend that presents example quantities that are scalar or aggregated as vectors or matrices that a computer may use to implement the generation and propagation of vector decompositions through a sequence of transformer blocks;

FIG. 4 is a legend that presents example propagation equations that a computer may use to implement the generation and propagation of vector decompositions through a sequence of transformer blocks;

FIG. 5 is a legend that presents additional example propagation equations that a computer may use to implement the generation and propagation of vector decompositions through a sequence of transformer blocks;

FIG. 6 is a flow diagram that depicts example computer process to conserve time and space while generating a local explanation, by propagating vector decompositions upwards, to discover why a transformer model inferred an output;

FIG. 7 is a flow diagram that depicts example computer activities that conserve time and space while generating a local explanation, by propagating vector decompositions upwards, to discover why a transformer model inferred an output;

FIG. 8 is a block diagram that illustrates a computer system upon which an embodiment of the invention may be implemented;

FIG. 9 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is conservation of time and space while generating a local explanation, by tracing decomposed token contributions through neural layers, to discover why a transformer language model made an inference. This introduces Generalized Lane-wise Additive Decomposition (GLAD) that is an explainability method for large language models (LLMs) or any transformer-based neural network model. This approach measures the importance of each input token in a linguistic prompt that produces a specific output, highlighting the most important input tokens. This enhances transparency in the LLM's decision-making process by clarifying which inputs contribute to a given output. This approach is the new state of the art in terms of computer internal efficiency for high accuracy. This approach outperforms the most widely adopted methods on faithfulness metrics. Compared to the theoretically best method in the literature, the approach herein achieves lower complexities for both memory usage (linear vs. quadratic in the number of input tokens) and running time (linear vs. cubic in the number of input tokens).

Given any single output token generated by a transformer model, this approach calculates a row vector of the same size as the number of input tokens. Each entry in this vector is an attribution value of an associated input token, and this vector may be referred to herein as a token attribution vector. For a generative LLM where the output is a sequence of tokens, this approach can be used to compute a token attribution vector associated with the entire output sequence by merging the token attribution vectors of each of the output tokens in the sequence. Merging can be done, for example, by aggregation.

A transformer model for language modeling such as an LLM takes as input a sequence of tokens and outputs a vector of (e.g. logarithmic, i.e. not probability) likelihoods of the same size as the vocabulary that the model supports, which is one likelihood value per distinct possible output token. This approach may inspect the log-likelihood vector, which contains the logarithm of the likelihoods. In the token attribution vector computed by this approach, the attribution value associated with each input token is the contribution of that token to the log-likelihood of the output token. The sum of the attribution values is approximately equal to the log-likelihood of that output token.

In order to determine the attribution values, the log-likelihood vector should be decomposed into a set of row vectors, one per input token, such that the sum of these vectors is equal to the log-likelihood vector. Consequently, each vector in this decomposition is of the size of the vocabulary supported by the model as discussed later herein. This set of vectors is referred to herein as a vector decomposition of the log-likelihood vector. To obtain the vector decomposition of the log-likelihood vector at the output of the model, this approach initializes another vector decomposition at the first transformer sublayer of the model. Then, this approach propagates this decomposition through the model while ensuring that each vector in the decomposition consistently represents the contribution of a respective single input token. At the output, this approach inspects the decomposition of the log-likelihood vector to derive the above token attributions vector. At initialization and throughout the propagation phase, the size of the decomposition vectors can vary depending on the model block they are propagated through, but a count of vectors remains constant and equal to the number of input tokens. Eventually, the vectors are propagated through all model blocks after the initialization point.

For GLAD, propagating the vector decomposition through the model's linear blocks is straight-forward so long as design invariants are maintained. For model nonlinear blocks, a linear approximation may be required. The goal is to update the vector decomposition as it gets propagated through the model, while maintaining the separation between the decomposition vectors associated with different input tokens. Linear operations allow that by design whereas nonlinear operations do not.

Much distinctiveness of GLAD is due to a vector decomposition that is more compact without loss of information about the log-likelihood vector. The fact that GLAD's vector decomposition is more compact provides GLAD's lower memory footprint and GLAD's faster running time. This is because the computations required for vector decomposition propagation involve significantly smaller tensors and less complex operations than the state of the art that requires multiple vectors for each input token. In contrast, GLAD's propagation algorithm requires only a single vector decomposition irrespective of the number of input tokens. GLAD's performance scales better for prompt length than the state of the art.

An embodiment may specially handle multi-head self-attention (MHSA) layers of transformer-based language models. In this case, the sufficient explanation statistic is the last hidden state of the final layer, immediately preceding the language modeling head. The goal is to find a valid vector decomposition initialization coupled with an efficient decomposition propagation rule through the MHSA layer to obtain the decomposition of the last output hidden state of the last transformer block's attention layer. This vector decomposition can be propagated throughout the remaining layers of the last transformer block to obtain the vector decomposition of the output vector. This vector decomposition is propagated through the language modeling head to obtain the contribution of each input token to the likelihood of each token in the vocabulary, effectively providing the desired token attributions.

An embodiment may calculate the token attributions for a single (e.g. latest) output token, even if the output is a sequence of multiple tokens. Firstly, the token attributions are computed for the first output token in the sequence based on the input tokens. For the following output token, similarly to token sequence generation, the previous output token is considered part of the input and the token attributions are computed for the following token accordingly. The process is similar for the tokens that follow up until the end of the sequence, where each time all the previous tokens are considered part of the input. The result is as many token attributions vectors as the number of output tokens in the sequence. The attribution vectors computed in the sequence's token order have each one extra dimension compared to the previous vector. To attribute the output sequence, this approach truncates all of these vectors by retaining only the attribution values associated with the original input tokens and discarding those associated with the output tokens. Consequently, all the vectors have the same dimension that is equal to the number of orignal input tokens. Finally, the vectors are element-wise aggregated either by averaging or by taking the maximum value.

This approach has at least the following innovations. This approach implements a mathematical formula to efficiently derive a compact vector decomposition from the first attention layer in a transformer-based model that is sufficient, if properly propagated, to compute the token attributions vector associated with the output token. This approach implements a mathematical formula for properly propagating the compact vector decomposition through subsequent attention layers of the model. This approach implements a mathematical formula for propagating a vector decomposition through log-softmax/softmax operations to obtain an estimate of the decomposition of the log-likelihood/likelihood of each output token. Herein is attribution of an output sequence, including an efficient aggregation method for the token attributions vectors to derive a token attributions vector for an entire sequence of output tokens. This may be the first presentation of attribution vectors for entire token sequences. This approach has new evaluation metrics adapted for evaluating token attribution methods on text generation tasks.

This approach has at least the following advantages. To increase fidelity, GLAD is sensitive to the output, and the attribution values herein depend on the predicted token. For acceleration, GLAD does not compute a gradient. GLAD has lower memory complexity with linear memory overhead to the number of input tokens, instead of a quadratic overhead. GLAD has lower compute overhead measured by the number of tensor operations, the compute overhead for propagating the vector decomposition through an attention layer is linear.

### 1.0 Example Computer

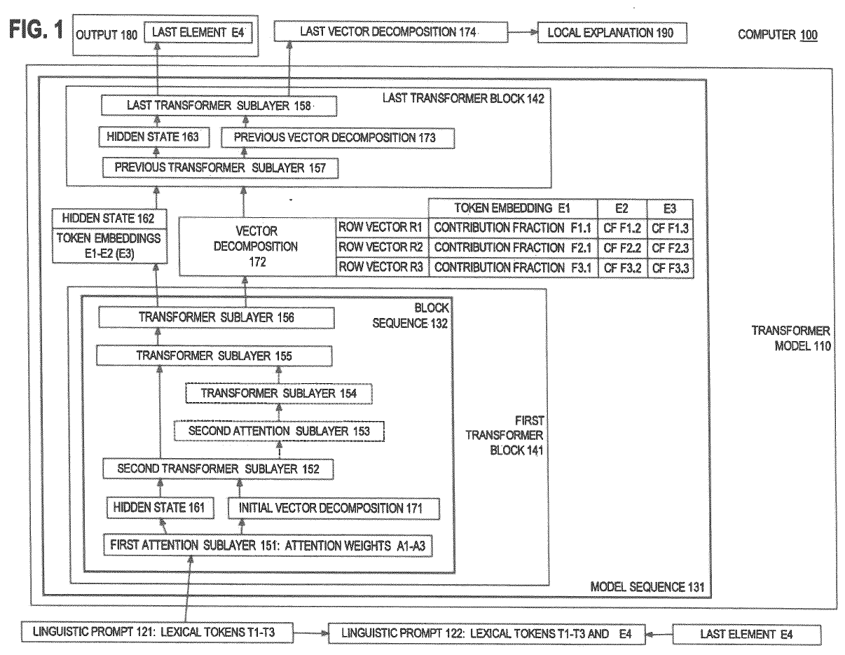

FIG. 1 is a dataflow diagram that depicts an example computer 100 that conserves time and space while generating local explanation 190, by propagating vector decompositions 171-174 upwards, to discover why transformer model 110 inferred output 180. Computer 100 may be one or more computers such as a rack server such as a blade, a personal computer, a mainframe, or a virtual computer. All components shown in FIG. 1 may be respectively stored and operated in volatile or nonvolatile storage of computer 100.

Transformer model 110 is a large language model (LLM) that is based on a so-called vertical “stack” of natural language processing (NLP) transformer blocks 141-142. The arrows shown in FIG. 1 indicate that data flows from linguistic prompt 121 at the bottom of the stack upwards through transformer model 110 to LLM results 174 and 180, from which local explanation 190 is generated. This dataflow conserves time and space inside transformer model 110.

Transformer model 110 contains the following hierarchy of nested data structures, including model sequence 131 that is both: a) a sequence of multiple transformer blocks 141-142 and b) as discussed later herein, a sequence of some or all of transformer sublayers 151-158. First transformer block 141 contains block sequence 132 that is a sequence of multiple transformer sublayers 151-156. Between transformer sublayers 156-157 is the boundary between transformer blocks 141-142. Techniques herein: a) are unaffected by boundaries between transformer blocks, b) may generally operate without regard for block boundaries, and c) generally processes subsequent (i.e. not the first sublayer) transformer sublayers 152-158 more or less similarly, regardless of position within model sequence 131. However as discussed herein: a) some components at the top and bottom of the stack are specially processed; and b) in every transformer block 141-142, differently-processed types of transformer sublayer may depend on position inside the transformer block. For example typically, the first transformer sublayer in each of transformer blocks 141-142 is an attention sublayer as discussed later herein.

### 1.1 Natural Language Processing (NLP)

In operation, transformer model 110 accepts linguistic prompt 121 as a whole input, which causes transformer model 110 to responsively inferentially generate output 180. The type of output 180 depends on the architecture of transformer model 110 as discussed later herein, which depends on the application as follows. In an embodiment, transformer model 110 inferentially generates output 180 as text that is informal natural language or is a formal language such as a programing or data language such as imperative JavaScript, declarative JavaScript object notation (JSON), declarative structured query language (SQL), or declarative hypertext markup language (HTML).

Text herein may be processed or generated as a sequence of lexical tokens, where each token may be a sequence of one or more characters such as a natural word. For example as shown, linguistic prompt 121 consists of two lexical tokens T1-T2. In a generative embodiment: a) output 180 may be an inferentially generated sequence of multiple tokens; and b) output 180 is text and, for example, last element E4 may be that latest output lexical token that was inferred so far by transformer model 110 as discussed later herein. In a nongenerative embodiment: a) output 180 instead is a classification (i.e. inferred class) that may, for example, be represented by last element E4 a single lexical token as discussed later herein; and b) output 180 consists solely of last element E4. In an embodiment, linguistic prompt 121 is natural language that is a question or command; and/or output 180 is responsive natural language such as an answer to the question or a summary as a response to the command.

### 1.2 NLP Explanability

A technologic problem is that there may be no readily apparent correspondence between data structures 121 and 180 even though output 180 was inferred from linguistic prompt 121. Local explanation 180 is a textual or graphical explanation of why transformer model 110 inferred output 180 from linguistic prompt 121, regardless of whether output 180 is a classification or text. Generation of local explanation 180 is based on internal operation of transformer model 110 as follows.

Each of multiple types of transformer sublayer has its own respective count of one or multiple neural layers as discussed later herein. For example, attention sublayers 151 and 153 each has multiple neural layers as discussed later herein. Acceptance of linguistic prompt 121 as input by transformer model 110 causes feedforward neural activation through the entirety of model sequence 131 from first attention sublayer 151, through most (or all as discussed later herein) of transformer sublayers 152-158. One feedforward activation through all of model sequence 131 inferentially generates one element that may be either: a) component E4 (i.e. 180) as a classification or b) a next element (not shown) in a (e.g. partial so far) output 180 and, this next element is last element E4 only when output 180 is fully generated. Here, (b) is generative, and (a) is not. Here, text generation by (b) entails a sequence of multiple feedforward activations, each separately through all of model sequence 131 as discussed later herein. First attention sublayer 151 generates attention weights A1-A3 as discussed later herein.

Herein, transformer model 110 may have two mutually exclusive feedforward activation modes that are live inferencing and post-hoc (i.e. afterwards) explaining. During live inferencing, each individual neural layer accepts a multivalued input and responsively inferentially generates a multivalued output, and the output of the previous neural layer is the input of the next neural layer. For example, first attention sublayer 151 inferentially generates hidden state 161 as an output that second transformer sublayer 152 accepts as input. That is, hidden state 161 operates as both an input and an output inside block sequence 132.

### 1.3 Hidden State

Although shown only in hidden state 162, herein all hidden states 161-163 have a similar or identical structure and, in an embodiment, their capacity may differ (i.e. contain different counts of numbers as follows). As shown, hidden state 162 contains at least token embeddings E1-E2 as discussed later herein. Each of token embeddings E1-E3 is a vector of real numbers (i.e. numeric values) that represents (i.e. is an embedding of) a respective distinct one of lexical tokens T1-T2. Each of hidden states 161-163 has exactly as many token embeddings as linguistic prompt 121 has tokens. Because linguistic prompts 121-122 have different lengths (i.e. counts of tokens) as discussed later herein, the count of token embeddings in each of hidden states 161-163 depends on which prompt is used.

Herein, every transformer block 141-142 accepts a previous hidden state as input and inferentially generates a next hidden state as output. Although not shown, the input to first transformer block 141 is a hidden state that contains token embeddings that are initial (i.e. learned default) embeddings. Likewise although not shown, the output from last transformer block 142 is a hidden state from which data structures E4 and 180 can be generated as discussed later herein.

In model sequence 131, different hidden states may have token embeddings of different respective sizes, and all token embeddings in a same hidden state have a same size (a.k.a. dimension, i.e. count of values). For live inferencing, one respective hidden state is the only data transferred between two adjacent transformer sublayers or between two adjacent transformer blocks. For live inferencing, only output 180 is generated, and components 174 and 190 are not generated. During live inferencing, both of components 121 and 180 are recorded for later reuse during post-hoc explaining.

### 1.4 Blocks, Sublayers, and Neural Layers

All neural layers in model sequence 131 have trained neural connection weights, and all of those neural layers are individually capable of learned operations such as: a) integrating multiple input hidden-state values of one activation to infer one of multiple output hidden-state values of the activation and b) reusing one of multiple input hidden-state values to infer multiple output hidden-state values. Model sequence 131 has the following nonlinearities based on the following transformer sublayer types.

Three transformer sublayer types herein are attention sublayer, add-and-norm sublayer, and multilayer perceptron (MLP) sublayer. Herein, an MLP layer is also referred to as a feedforward sublayer, which consists of multiple neural layers. Herein, an add-and-norm sublayer contains exactly one trainable neural layer that is based on variance that is nonlinear, and that individual neural layer is referred to herein as a normalization layer that is a dense (i.e. fully connected) layer.

Herein, every type of transformer block has at least one of each of the three types of transformer sublayer. Herein, every type of transformer sublayer and every type of transformer block are nonlinear. Types of transformer block are discussed later herein. In that way, model sequence 131 has compounded nonlinearities that make it technologically difficult to generate local explanation 190, and the state of the art needs excessive time and space to explain transformer model 110. The following feedforward neural activation propagation innovation facilitates generating local explanation 190 in unconventionally less time and space.

### 1.5 Vector Decomposition

As discussed earlier herein, for live inferencing, one respective hidden state is the only data transferred between two adjacent transformer sublayers or between two adjacent transformer blocks. For live inferencing, hidden state 162 contains all three token embeddings E1-E3 for respective lexical tokens T1-T3, and each token embedding is a vector. By definition herein during post-hoc explaining, hidden state 162 should not: a) consist solely of vector(s) and b) contain a same count of vectors as during live inferencing. Herein during post-hoc explaining, hidden state 162 instead contains: a) token embeddings E1-E2 but not E3 and b) vector decomposition 172 that is a sequence of row vectors R1-R3 that each is a vector of real numbers.

Lexical tokens T1-T3 respectively correspond to token embeddings E1-E3 that respectively correspond to row vectors R1-R3. Token embeddings E1-E3 and row vectors R1-R3 have a same structure and, although row vectors R1-R3 have a same capacity (i.e. dimension), the dimension of row vectors R1-R3 is not the dimension of token embeddings E1-E3. Likewise, a token embedding and a row vector have different semantics. A count of contribution (i.e. attribution) fractions in each of row vectors R1-R3 is the same as a count of row vectors R1-R3 in vector decomposition 172, which is the same as a count of lexical tokens T1-T3 in linguistic prompt 121. Vector decomposition 172 logically is a square matrix and may, for example, be implemented as a square matrix.

Row vectors R1-R3 respectively contain respective multiple contribution fractions F1.1-F1.3, F2.1-F2.3, and F3.1-F3.3 that are real numbers from zero to one that quantitatively measure how important (i.e. influential) is each of lexical tokens T1-T3's contribution to each of token embeddings E1-E3. A contribution fraction (CF) value of zero indicates utter irrelevance of a first lexical token that had no influence on the generation of a token embedding of a second lexical token, and one indicates a perfect correlation between the token embedding and the first lexical token. For example, contribution fraction (CF) F3.2 is the relative magnitude of the contribution by lexical token T3 to token embedding E2 (i.e. of lexical token T2). In an embodiment, contribution fractions F1.2, F2.2, and F3.2 sum to one. In an embodiment, CF values range from −1 to 1, with zero still indicating irrelevance, and with negative values indicating (i.e. insufficient) influence against generating output 180. Vector decomposition 172 contains data F1.1-F1.3, F2.1-F2.3, F3.1-F3.3, and R1-R3. Vector decomposition 172 does not contain token embeddings E1-E3 that are contained only in hidden state 162, even though embeddings E1-E3 are demonstratively shown in vector decomposition 172.

Hidden states always and vector decompositions only during post-hoc explaining are generated by neural activation of model sequence 131. Vector decomposition 172 is a decomposition of (e.g. implied) last token embedding E3, where the decomposition is by contribution per lexical token. Herein, an implied last token embedding can be materialized (i.e. generated) by summation (i.e. addition) of all row vectors in the vector decomposition, and a row vector may be referred to herein as an addend vector, a summand vector, a contribution vector, or an attribution vector. During post-hoc explaining, token embedding E3 is generated by summation of row vectors R1-R3, and token embeddings E1-E2 are instead generated directly by neural activation. During live inferencing, all token embeddings E1-E3 are instead generated directly by neural activation, and vector decomposition 172 is not generated.

### 1.6 Functional Architectures

During post-hoc explaining: technologic accuracy of local explanation 190 is independent of all of: a) the length of linguistic prompt 121, b) the size (i.e. count of numbers) of token embeddings E1-E3, and c) the height of transformer model 110, which herein is the length of model sequence 131 measured in transformer blocks, transformer sublayers, or neural layers. Herein during live inferencing, increased model stack height or token embedding width increases both of: a) technologic accuracy of components 110 and 180 and b) consumption of time and space.

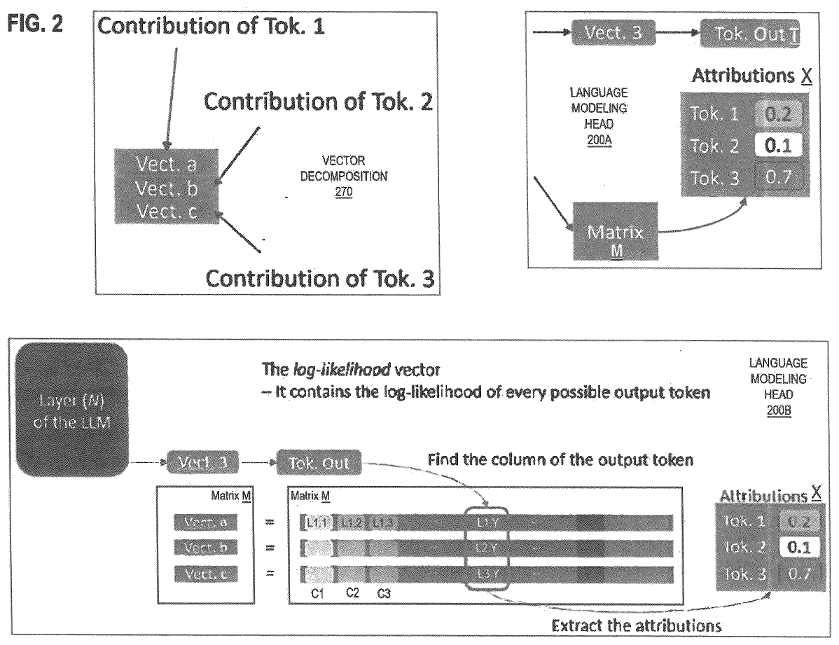

Although not shown, on top of the stack of transformer model 110 may be a language modeling head that decodes output hidden state (not shown) always and last vector decomposition 174 during post-hoc explaining. The language modeling head contains at least one neural layer. The language modeling head: a) generates last element E4 from the output hidden state from last transformer block 142 and b) during post-hoc explaining, generates local explanation 190 from data structures 121, 174, and 180. A language modeling head is discussed later for FIG. 2.

Herein are two complementary (i.e. combinable) functional embodiments and three mutually-exclusive architectural embodiments. The two functional embodiments are: a) a nongenerative encoder transformer model that can, for example, infer a classification or a score and b) a (e.g. natural or other language) generative decoder transformer model. The three architectural embodiments are: i) an encoder-only transformer model that has no decoder, ii) a decoder-only transformer model, and iii) an encoder-decoder transformer model in which case transformer model 110 may have, instead of a single model sequence 131, a sequence of two model sequences that are an encoder model sequence followed by a decoder model sequence. The encoder-only transformer model does not contain an encoder. Each of the encoder and decoder contain a respective model sequence 131, or the encoder and decoder each contain a multi-sublayer subsequence of model sequence 131.

Herein, there are two types of transformer block that are: 1) a tall transformer block that contains all transformer sublayers 151-156 and 2) a short transformer block that contains transformer sublayers 151-152 and 155-156 but not 153-154 that are shown dashed in FIG. 1. Herein all transformer blocks are short transformer blocks, except that the decoder in an encoder-decoder transformer model contains tall transformer blocks.

### 2.0 Example Language Modeling Head

FIG. 2 is a block diagram that depicts vector decomposition 270 and language modeling head 200A-B that are different representations of a same language modeling head. Herein, a language modeling head is not an attention head. Vector decomposition 270 may be any of vector decompositions 171-174. For example, vectors a-c may be row vectors R1-R3, and tokens 1-3 may be lexical tokens T1-T3. In that case, contribution fractions F2.1, F2.2, and F2.3 are collectively shown as “Contribution of Tok. 2” (i.e. vector b). However, language modeling head 200A-B is invoked only when vector decomposition 270 is last vector decomposition 174.

The left side of language modeling head 200A shows two arrows that represent two inputs to language modeling head 200A that are vector 3 and matrix M. During live inferencing, vector 3 is the sole input to language modeling head 200A. During post-hoc explaining, both data structures M and 3 are parts of a whole input to language modeling head 200A. Token out T is generated from vector 3. During live inferencing, attributions X is absent (i.e. not generated), and matrix M is absent (i.e. not received from nor generated by last transformer sublayer 158). During post-hoc explaining, attributions X is generated from matrix M. Here: a) matrix M is last vector decomposition 174 that does not contain token embeddings as discussed below; and b) generated from vector 3, token out T is last element E4.

Depending on the embodiment, local explanation 190 is attributions X or is generated from (i.e. based on) attributions X. Depending on the embodiment, local explanation 190 may be displayed or sent to a user: a) in tabular form such as shown attributions X, b) as linguistic prompt 121 containing lexical tokens differently shaded (e.g. colored) according to a corresponding importance magnitude in attributions X (i.e. input token importances), or c) as a bar chart with one bar per each lexical token T1-T3. In one embodiment of (b), there are only two distinct shades, which is one color for tokens whose importance value is positive and another color for tokens whose importance value is negative. A third color may be used for (e.g. nearly) irrelevant tokens. In another embodiment of (b), coloration is a continuous spectrum (i.e. range of colors or shades) because importances have a continuous value range.

Language modeling head 200B accepts both data structures M (i.e. vectors a-c) and 3 as parts of a whole input during post-hoc explaining, and this whole input is the output hidden state from layer N (i.e. last transformer sublayer 158). Here, vector 3 is also referred to as a log-likelihood vector, which contains a logarithmic likelihood numeric value for each distinct lexical token in a predefined vocabulary of transformer model 110 that is referred to as “LLM” (large language model) in FIG. 2. Each predefined vocabulary token is assigned a distinct ordinal (i.e. whole or natural number) that can be used as an (e.g. array) offset into vector 3 to inspect the log-likelihood value of that token as discussed below.

In FIG. 1, contribution fractions F1.1-F1.3, F2.1-F2.3, and F3.1-F3.3 are demonstratively arranged as a two dimensional table, with one row per row vector and one column per lexical token T1-T3. In language modeling head 200A in FIG. 2, matrix M has a similar arrangement except that: a) the dimension (i.e. length) of vectors a-c is the count of predefined distinct vocabulary lexical tokens, not the count of lexical tokens T1-T3 in linguistic prompt 121; and b) log-likelihoods L1.1-L1.3 and L1.Y-L3.Y are not contribution fractions. The count of vectors a-b is the same as the count of row vectors R1-R3.

As demonstratively shown in language modeling head 200B as variously shaded vertical columns, each distinct column (e.g. C1-C3) in vectors a-c has a distinct column ordinal (i.e. offset) that is the same as the ordinal of the corresponding predefined vocabulary lexical token. In that way, the ordinal of token out T can be used as a column ordinal to identify the column that contains log-likelihoods L1.Y-L3.Y. By definition: a) the ordinal of token out Tis the (e.g. array) offset of the highest log-likelihood value in vector 3, and that is how token out T is finally inferred; and b) token out T has the highest sum of log-likelihood values (i.e. L1.Y-L3. Y) in matrix M. Log-likelihoods L1.Y-L3.Y contribute to attributions X, and log-likelihoods L1.1-L1.3 do not.

### 3.0 Example Implementation Quantities

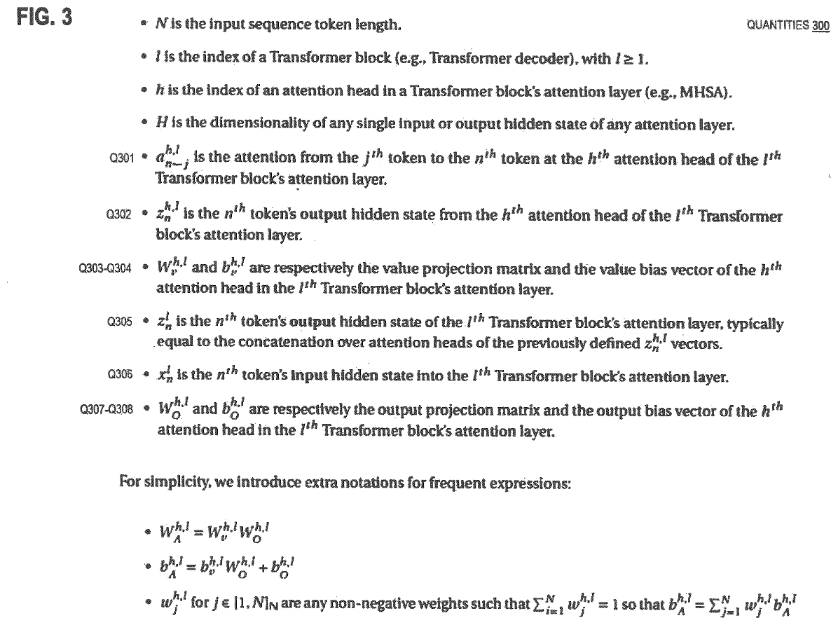

FIG. 3 is a legend that presents example quantities 300 that are scalar or aggregated as vectors or matrices that computer 100 may use to implement the generation and propagation of vector decompositions 171-174 in model sequence 131. The following quantities have the following meanings in quantities 300.
N is the input sequence token length.
l is the index of a Transformer block (e.g., Transformer decoder), with l≥1.
h is the index of an attention head in a Transformer block's attention layer (e.g. MHSA, multi-head self-attention).
H is the dimensionality of any single input or output hidden state of any attention layer. Q301 is the attention from the j^{th} token to the n^{th} token at the h^{th} attention head of the l^{th}Transformer block's attention layer.
Q302 is the n^{th} token's output hidden state from the h^{th} attention head of the 7th Transformer block's attention layer.
Q303-Q304 are respectively the value projection matrix and the value bias vector of the h^{th} attention head in the l^{th} Transformer block's attention layer.
Q305 is the n^{th} token's output hidden state of the 1th Transformer block's attention layer, typically equal to the concatenation over attention heads of the previously defined z^{h,l} vectors.
Q306 is the n^{th} token's input hidden state into the 1th Transformer block's attention layer.
Q307-Q308 are respectively the output projection matrix and the output bias vector of the h^{th} attention head in the l^{th} Transformer block's attention layer.

Quantities 300 are for a multi-head attention sublayer. Herein, a multi-head attention sublayer may contain neural linear layers that project Query (Q), Key (K), and Value (V) inputs and, for increased accuracy, these attention linear layers include a bias term. In first attention sublayer 151, attention weights A1-A3 shown in FIG. 1 are not the raw unnormalized measures of how relevant one respective input token is to another, calculated as the scaled dot product between their respective Query and Key vectors. Instead, the raw measurements are converted into attention weights A1-A3 via softmax, which determine how information is finally aggregated in the attention mechanism. Each of attention weights A1-A3 corresponds to a distinct respective one of lexical tokens T1-T3.

### 4.0 Example Propagation Equations

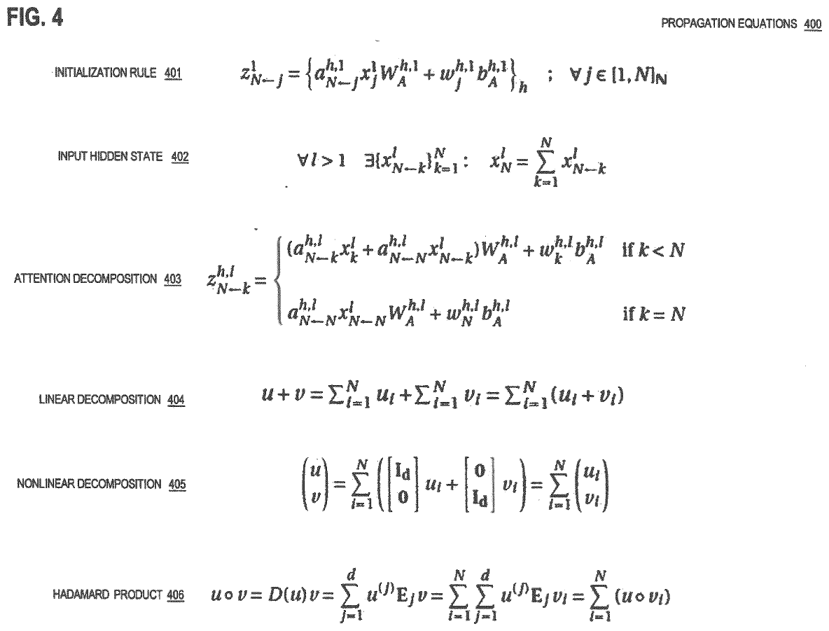

FIG. 4 is a legend that presents example propagation equations 400 that computer 100 may use to implement the generation and propagation of vector decompositions 171-174 in model sequence 131. Based on quantities 300 in FIG. 3, the following equations have the following meanings in propagation equations 400 in FIG. 4.

Initialization rule 401 generates initial vector decomposition 171. Input hidden state 402 is any of hidden states 161-163. Attention decomposition 403 generates an output vector decomposition from any attention sublayer other than first attention sublayer 151, such as output from second attention sublayer 153 or, if previous transformer sublayer 157 is an attention sublayer, previous vector decomposition 173. Each of propagation equations 401 and 403 uses a separate instance of scalar (i.e. number) quantity 301 for each of multiple attention heads in a (i.e. first or not) attention sublayer. Linear decomposition 404 can generate a vector decomposition from any linear neural layer in various types of transformer block. Nonlinear decomposition 405 generates an output vector decomposition from any transformer sublayer such as an add-and-norm sublayer or a multilayer perceptron (MLP) sublayer as discussed earlier herein.

Hadamard (i.e. bilinear) product 406 of any two vectors u-v, may generate a decomposition of each of vectors u-v or, in an accelerated embodiment, only for one of vectors u-v. Counterintuitively, an additional decomposition in Hadamard product 406 decreases accuracy of later components 174 and 180 due to large summations on low exponent precisions such as block floating point 16-bit (BFP16) that is two bytes (e.g. halfword) designed to be the most compact real number format specifically for deep learning and artificial intelligence. The accelerated embodiment of Hadamard product 406 is a propagation rule that consumes less time and space by using the minimum required tensor operations for the propagation. Vector Hadamard product is a symmetric operation that entails a design decision with the accelerated embodiment about which decomposition to propagate when both operands have a vector decomposition. This choice is model architecture-dependent. In Meta's Large Language Model Meta AI (LlaMa)'s multilayer perceptron (MLP) block, herein the vector decomposition stemming from the up projection propagated, while Swish Gated Linear Unit (SwiGLU, i.e. more accurate than ReLU, Rectified Linear Unit) activation vectors are used as-is.

### 5.0 More Example Propagation Equations

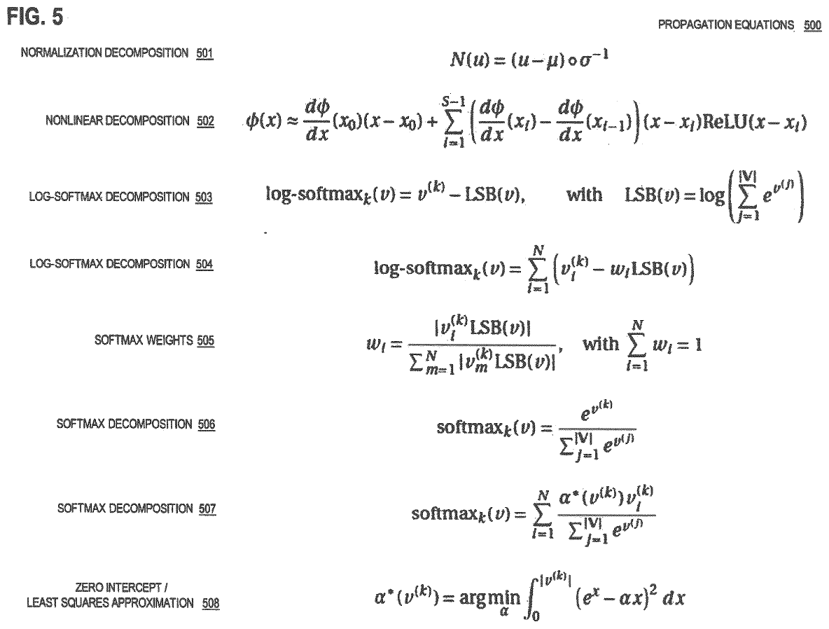

FIG. 5 is a legend that presents more example propagation equations 500 that computer 100 may use to implement the generation and propagation of vector decompositions 171-174 in model sequence 131. Propagation equations 400 and 500 in FIGS. 4-5 are complimentary and used together. Based on quantities 300 in FIG. 3, the following equations have the following meanings in propagation equations 500 in FIG. 5.

Normalization decomposition 501 generates a vector decomposition from a normalization layer (e.g. part of an add-and-norm sublayer) as discussed earlier herein. Nonlinear decomposition 502 may be used for propagation through a gating mechanism for a mixture of experts (MoE, i.e. differently trained neural subnetworks connected in a learned dynamically switchable way for increased accuracy). Each of log-softmax decompositions 503-504 generates a vector decomposition that, as discussed earlier for FIG. 2, can be used to generate an output lexical token such as last element E4 in FIG. 1, and shown “LSB” is a logarithm sum bias function. Softmax weights 505 provides coefficients used in log-softmax decomposition 504. Each of softmax decompositions 506-507 generates a vector decomposition. Zero-intercept least-squares approximation 508 provides coefficients used in softmax decomposition 507.

### 6.0 Example Local Explanation Process

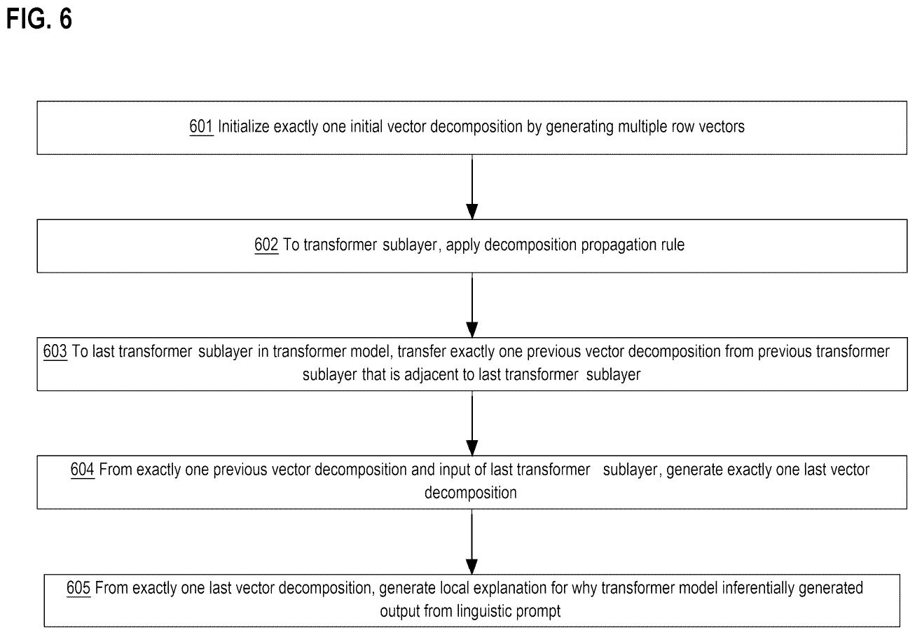

FIG. 6 is a flow diagram that depicts an example process that computer 100 performs to conserve time and space while generating local explanation 190, by propagating vector decompositions 171-174 upwards, to discover why transformer model 110 inferred output 180.

Step 601 initializes exactly one initial vector decomposition 171 by generating multiple row vectors, which is one row vector per each lexical token T1-T3. An embodiment of step 601 may implement initialization rule 401. To each of subsequent transformer sublayers 152 and 155-158, step 602 applies a respective decomposition propagation rule. Any propagation equation herein that generates an output vector decomposition as discussed for FIGS. 4-5 may be used as a decomposition propagation rule by step 602, although which decomposition propagation rule may depend on the type of transformer sublayer as discussed elsewhere herein.

To last transformer sublayer 158, step 603 transfers exactly one previous vector decomposition 173 from previous transformer sublayer 157 that is adjacent to last transformer sublayer 158. From input hidden state 162 and exactly one previous vector decomposition 173, step 604 inferentially generates exactly one last vector decomposition 174 as discussed earlier herein. From exactly one last vector decomposition 174 and data structures 121 and 180, step 605 generates local explanation 190 for why transformer model inferentially generated output 180 from linguistic prompt 121. In an embodiment, step 605 operates a language modeling head as discussed earlier for FIG. 2.

### 7.0 Example Local Explanation Activities

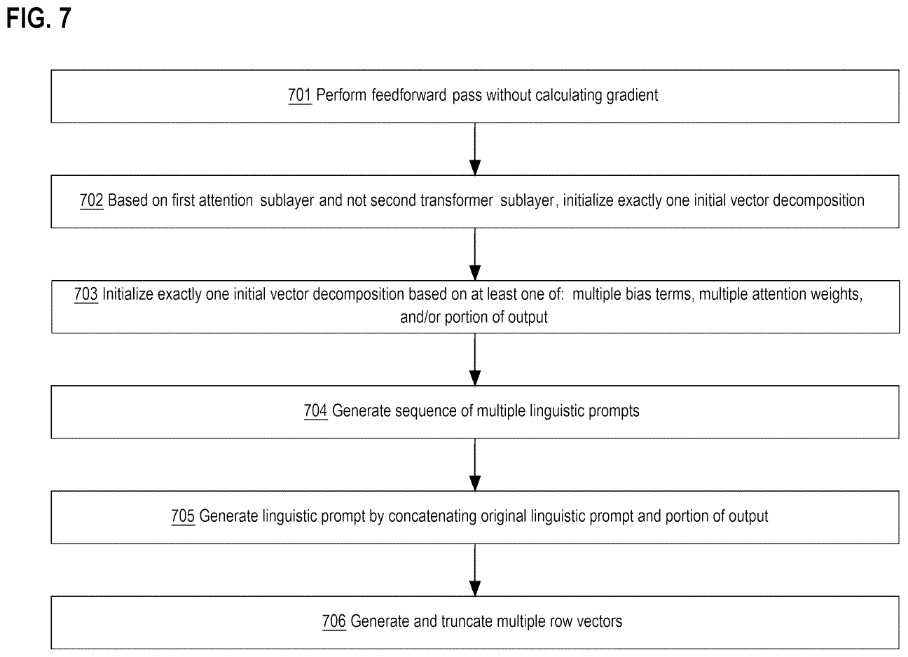

FIG. 7 is a flow diagram that depicts example explanation activities that computer 100 may perform to conserve time and space while generating local explanation 190, by propagating vector decompositions 171-174 upwards, to discover why transformer model 110 inferred output 180. The processes and steps of FIGS. 6-7 are compatible and may be combined or interleaved.

Step 701 perform a neural feedforward pass through the entire length of model sequence 131 without calculating a gradient and, for acceleration, the approach herein does not measure gradient. Steps 702-705 are sub-steps of step 701.

Model sequence 131 contains multiple transformer blocks that each contains at least one attention sublayer and, in that way, model sequence 131 contains multiple attention sublayers. First attention sublayer 151 in first (i.e. bottom) transformer block 141 is a first attention sublayer in model sequence 131. An embodiment of model sequence 131 may contain second attention sublayer 153 in a second transformer block as a second attention sublayer in model sequence 131. In another embodiment, a second attention sublayer in model sequence 131 may be a first transformer sublayer in a second transformer block that is above (i.e. after) transformer block 141. Based on first attention sublayer 151 and not a second transformer sublayer, step 702 initializes exactly one initial vector decomposition 171, which is the only initial vector decomposition for this neural feedforward pass through the entire length of model sequence 131. All other vector decompositions 172-174 for this neural feedforward pass through the entire length of model sequence 131 are derived by neural activation from the previous vector decomposition from the previous transformer sublayer for this neural feedforward pass.

Initialization steps 702-703 are complimentary and may be combined to generate exactly one initial vector decomposition 171. Step 703 initializes exactly one initial vector decomposition 171 based on at least one of: multiple bias terms, multiple attention weights A1-A3 shown in FIG. 1, and/or a portion of output 180. An embodiment of step 703 may apply initialization rule 401 to generate initial vector decomposition 171.

Step 701 is not the only neural feedforward pass through the entire length of model sequence 131 by the process of FIG. 7. The state of the art does not individually explain each lexical token in the sequence of multiple tokens in inferentially generated output 180. That is, the state of the art cannot sequentially explain output 180 but instead explains output text as an opaque, monolithic whole without regard for an individual lexical token in output 180. Steps 704-706 are innovative because they generate a local explanation of output 180 that is a sequential explanation of output 180 as an inferred output sequence of multiple lexical tokens. Step 704 generates sequence of multiple linguistic prompts, including one prompt and one neural feedforward pass through the entire length of model sequence 131 for each token in output 180 as follows.

Step 705 generates next linguistic prompt 122 by concatenating previous linguistic prompt 121 and the portion of output 180 generated so far. When previous linguistic prompt 121 is the first (i.e. original) prompt, no output 180 was yet generated. When previous linguistic prompt 121 is accepted and a next lexical token (e.g. last element E4) is inferentially generated in output 180, then: a) next linguistic prompt 122 can be generated by appending last element E4 onto previous linguistic prompt 121 to provide b) sequential context to the vector decomposition process as follows.

Step 704 may operate in a sequence of iterations and, in each iteration, may repeat step 705 to generate a distinct next linguistic prompt in each iteration. Step 706 (e.g. re-)generates all of vector decompositions 171-174 in each iteration. In total over all iterations, step 706 generates multiple instances of last vector decomposition 174. Each instance of last vector decomposition 174 contains (e.g. three) row vectors. There is one row vector in each of vector decomposition 171-174 for each of lexical tokens T1-T3.

Generating local explanation 190 as a sequential explanation entails generating an instance of last vector decomposition 174 for each of multiple linguistic prompts 121-122. How many contribution fractions does each row vector in vector decompositions 171-174 contain is the same as how long (i.e. count of lexical tokens) is the linguistic prompt. A technical problem is that linguistic prompts 121-122 have different lengths, and their row vectors have different respective lengths (i.e. count of contribution fractions). The prompt size in a sequence of linguistic prompts 121-122 increases monotonically by one (i.e. lexical token), and the row vector length increases monotonically by one (i.e. contribution fraction). That is, the first instance of last vector decomposition 174 contains the shortest row vectors, and this provides a shortest vector length. Step 706 truncates all row vectors in all instances of last vector decomposition 174 (i.e. not at vector decompositions 171-173) to have that shortest vector length.

Each truncated instance of last vector decomposition 174 is a local and sequentially contextual explanation of a respective lexical token in output 180. For example if output 180 contains a same token repeated twice, respective instances of last vector decomposition 184 may contain different contribution fraction values, regardless of whether the two occurrences of that same token are adjacent or not.

### 8.0 Examplary Pseudocode Implementation

The following is example pseudocode that computer 100 may implement to perform some or all of the steps of FIGS. 6-7.

Inputs:
X := {x1,..., xN } The input tokens, each xi being an input
token.
Y := {y1, ..., yS } The output sequence of tokens, each yi being
an output token.
M := The Transformer model (e.g, an LLM)
Output:
u := The attribution vector of the output sequence Y
Algorithm

| | |
|---|---|
| 1: | for each i in [1, S]N do: |
| 2: | Initialization step |
| 3: | Start the execution of M on the input X concatenated with |

the tokens {y1, ..., yi −1}

| | |
|---|---|
| 4: | Stop at the first block of type Attention |
| 5: | Propagate the model's internal vectors through the block |

(same as during inference)

| | |
|---|---|
| 6: | Initialize the vector decomposition VN |
| 7: | Attribution Step |
| 8: | while have not propagated VN through the last block of M do |
| 9: | Resume execution until the next block |
| 10: | Propagate the model's internal vectors through the block |

(same as during inference)

| | |
|---|---|
| 11: | Propagate the vector decomposition VN through the block: |
| 12: | ∘ For blocks of type Attention |
| 13: | ∘ For linear blocks |
| 14: | ∘ For nonlinear blocks |
| 15: | end while |
| 16: | Extract the token attributions vector ui for the output |

token yi from VN

| | |
|---|---|
| 17: | end for |
| 18: | Aggregation Step |
| 19: | for each i in [1, S]N do |
| 20: | Truncate the vector ui to length N |
| 21: | end for |
| 22: | u = the mean of the {u1, ..., uS } truncated vectors |
| 23: | return u |

### Hardware Over View

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

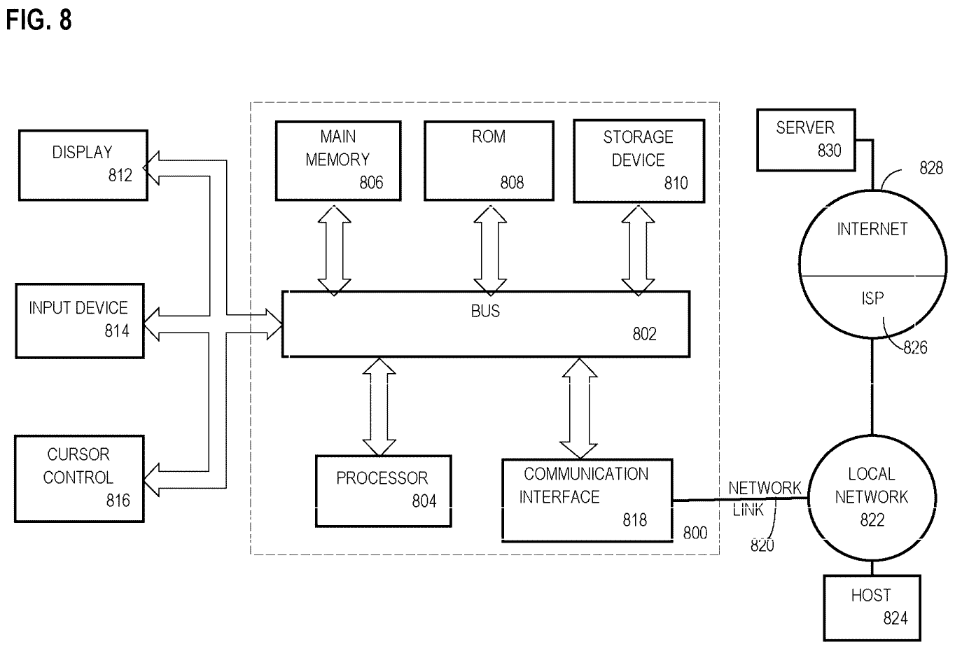

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Overview

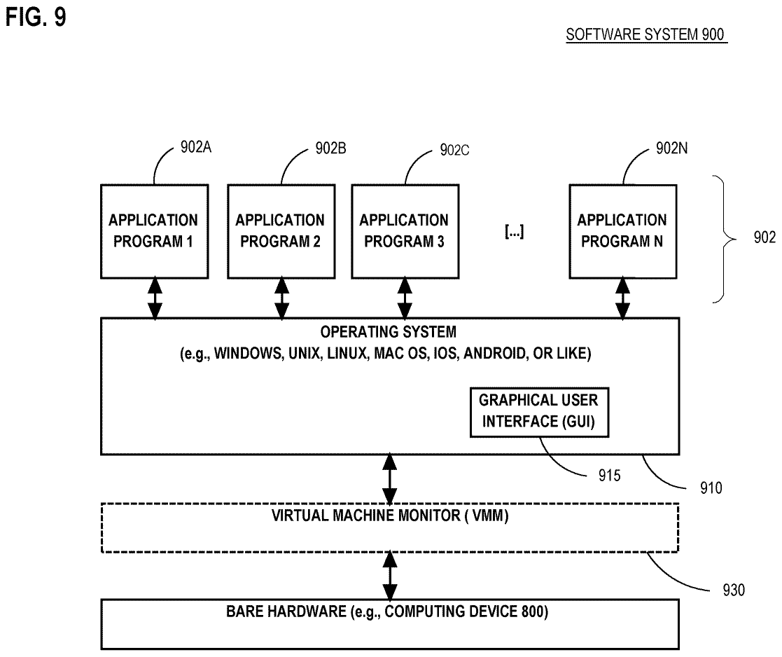

FIG. 9 is a block diagram of a basic software system 900 that may be employed for controlling the operation of computing system 800. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computing system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by the system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by the system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 25; 2 (1): 1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

### Large Language Models (LLMs)

In some illustrative embodiments, the mechanisms of the illustrative embodiments include or work in conjunction with Large Language Models (LLMs). LLMs are a class of artificial intelligence (AI) systems that employ deep learning architectures, such as transformer-based neural networks, to model and generate human-like natural language. These models are capable of understanding, processing, and generating textual content with high fluency and contextual relevance. Exemplary instances of such models include ChatGPT developed by OpenAI and Gemini (previously known as “Bard”) developed by Google LLC.

At their core, LLMs are statistical models trained on large-scale collections of unstructured natural language text. During training, the LLM is presented with sequences of tokens (typically representing words or sub-words) from these collections, or “corpora”, and learns to predict the probability distribution of the next token in the sequence, given the preceding context. This predictive modeling approach allows the LLM to learn syntactic structures, semantic relationships, contextual dependencies, and pragmatic cues present in natural language. The result is a system capable of performing a wide range of language-related tasks, including but not limited to, language modeling, text generation, machine translation, summarization, question answering, sentiment analysis, classification, and information retrieval.

The architecture of a typical LLM is built upon a deep neural network composed of multiple layers of self-attention and feedforward transformations, such as in a transformer architecture which uses a self-attention mechanism to process sequential data, such as text or audio in parallel rather than sequentially like a recurrent neural network (RNN). Each layer consists of multiple attention heads, layer normalization components, and residual connections. These components facilitate the model's ability to process and retain long-range dependencies across a text input. The model encodes input text as high-dimensional embeddings and transforms these embeddings through successive non-linear operations to derive context-aware representations, which ultimately inform the generation of output tokens.

As mentioned above, training an LLM requires exposure to a vast dataset of unstructured text, which may include web pages, books, articles, code repositories, and other publicly or commercially available sources. The training process typically involves unsupervised or self-supervised learning, wherein the model minimizes a loss function that penalizes inaccurate predictions of masked or subsequent tokens. Gradient-based optimization techniques, such as stochastic gradient descent (SGD) or the like, are employed to update the millions of model parameters over many iterations.

Once trained, an LLM is deployed for performing inference operations. As noted above, LLMs operate primarily in an autoregressive manner in that they are given an input sequence, and the LLM predicts the next most probable token in the sequence. The model then iteratively repeats this process, generating sequences of output tokens based on the evolving context. The input provided to the LLM is often referred to as a “prompt” and there is an entire area of study, referred to as “prompt engineering”, directed to the creation of appropriate prompts to obtain the best results from an LLM.

The LLM may be accessed through an interface or Application Programming Interface (API) that allows users to interact with the LLM via such prompts. The prompts themselves are a structured input string comprising one or more portions including an instructional portion, contextual portion, and operational portion. The instructional portion provides a natural language description of the task to be performed by the model. For example, “Translate the following paragraph into English” or “Summarize the main points of this document.” The contextual portion specifies the data or content upon which the task is to be executed, e.g., a body of text, a hyperlink to an online resource, a filename, a structured dataset, or the like. The data may be passed directly or indirectly, such as by referencing an external storage location.

An optional operational portion may be provided in the prompt to the LLM. The operational portion specifies software tools or executable utilities that the LLM is permitted or instructed to invoke when performing the requested task as specified in the instructional portion. Such tools can include functions for mathematical computation, database access, image processing, code execution, or custom analytics workflows. These tools may operate as discrete programs or callable APIs, and their output may be integrated into the LLM's processing pipeline to generate the response to the prompt.

In some cases, LLM prompts may further include formatting or template cues, few-shot examples, and special tokens or modifiers. The formatting or template cues may specify formatting constraints or delimiters to influence the structure of the output, e.g., “the output should be in JSON format”, use of bullet points, provide Extensible Markup Language (XML) tags. The few-shot examples may provide input-output pairs that serve as in-context demonstrations for the LLM to learn from within the prompt itself (also referred to as “few-shot learning”). The special tokens or modifiers may represent roles, commands, or model behaviors that the LLM is to exhibit.

When a prompt is input to a LLM, the prompt is first tokenized, i.e., transformed into a sequence of tokens using a tokenizer specific to the LLM's vocabulary. These tokens are then input into the LLM's embedding layers and processed sequentially via multi-headed self-attention mechanisms distributed across multiple transformer layers. The LLM generates its output token-by-token, with each subsequent token generated based on both the prompt and all previously generated tokens. This process allows the LLM to complete sentences, perform logical inference, or generate structured data, depending on the original prompt.

The LLM's internal representations are heavily influenced by the prompt's wording, token length, semantic specificity, and syntactic structure. Thus, small changes to a prompt, such as reordering phrases, changing tense, or altering punctuation, can yield significantly different outputs, underscoring the need for precise prompt engineering in production settings.

Inference in LLMs often involves probabilistic sampling from a learned distribution, which may be controlled via parameters such as temperature, top-k, or top-p (nucleus sampling). These mechanisms influence the diversity and determinism of the LLM's outputs. Advanced LLM implementations may further incorporate memory modules, retrieval augmentation (e.g., RAG models), multi-modal processing capabilities (e.g., combining text with images or audio), or system-level orchestration that allows for multi-agent collaboration or tool-assisted reasoning. Additionally, guardrails and alignment techniques may be applied to constrain the model's outputs to predefined safety or ethical guidelines.

The combination of scalable deep learning, prompt-based interaction, and extensible tool use makes LLMs a flexible platform for general-purpose AI applications across various domains such as education, law, healthcare, programming, and customer service.

### Prompt Engineering

As noted above, an important area of study in modern AI systems involving the use of LLMs is the area of prompt engineering since the output of an LLM is highly influenced by the particular content and configuration of the prompt that is input to it. Prompt engineering is a systematic process for designing and structuring input prompts in order to elicit desired behavior or output from a LLM. As the behavior of LLMs is highly dependent on the phrasing, structure, and context of the input prompt, prompt engineering involves strategic manipulation of prompts to achieve predictable and optimized outputs. Importantly, prompt engineering does not require retraining or fine-tuning of the underlying model(s) of the LLM. Instead, prompt engineering leverages the inherent capabilities of pretrained models by modifying the natural language or token-based instructions provided to the model so as to direct the model behavior in a desired direction.

The term “prompt” refers to the complete input provided to the LLM to induce the LLM to generate a particular output. Prompts can vary in structure depending on the task, with example elements of a prompt having been described previously.

Prompt engineering generally comprises a multi-step iterative process, including task definition, prompt design, prompt testing, evaluation and optimization, prompt finalization, and prompt versioning and adaptation. With the task definition step, the specific behavior or output required from the LLM is identified, e.g., classification, code generation, legal summarization, etc. In the prompt design step, an initial prompt is constructed that coveys the task and context, which may require careful selection of natural language phrasing, formatting requirements, and providing of examples and constraints for the LLM task being requested. The prompt testing step involves providing the constructed prompt to the LLM and observing the results generated by the LLM. The evaluation and optimization step, which may be performed iteratively with the prompt design and prompt testing steps, involves assessing the output against desired criteria, e.g., accuracy, completeness, tone, etc., and refining the prompt accordingly. The prompt finalization step involves locking in a prompt configuration for production use, such as storage in a prompt repository or otherwise made available for reuse, or integration into downstream applications. The optional prompt versioning and adaptation step involves maintaining multiple versions of prompts adapted for different models, user intents, or performance trade-offs.

Prompt engineering is an important enabling technique in various domains, including conversational agents and chatbots, legal, medical, or technical summarization, structured data extraction, automated code generation and debugging, AI-assisted creativity tools (e.g., story or image generation), and decision support systems. Prompt engineering enables these applications to be implemented without additional training data, thereby reducing development costs and enabling rapid prototyping.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
during a feedforward pass in a transformer model that contains a model sequence of multiple transformer sublayers:
a) transferring, to a last transformer sublayer in the transformer model, from a previous transformer sublayer that is adjacent to the last transformer sublayer, exactly one previous vector decomposition, and
b) generating, from the exactly one previous vector decomposition and an input of the last transformer sublayer, exactly one last vector decomposition; and
generating, from the exactly one last vector decomposition, a local explanation for why the transformer model inferentially generated an output from a linguistic prompt.

2. The method of claim 1 wherein the transformer model is at least one selected from a group consisting of:
a transformer model that does not contain an encoder and
a transformer model that contains a decoder that contains at least part of the model sequence of multiple transformer sublayers.

3. The method of claim 1 further comprising generating the linguistic prompt by concatenating an original linguistic prompt and a portion of the output.

4. The method of claim 1 wherein said generating the local explanation comprises generating and truncating a plurality of row vectors.

5. The method of claim 1 wherein the output is selected from a group consisting of: an output sequence of lexical tokens and exactly one lexical token in an output sequence of lexical tokens.

6. The method of claim 1 wherein:
the method further comprises generating a sequence of multiple linguistic prompts;
each prompt in the sequence of multiple linguistic prompts has a distinct count of tokens;
the counts of tokens of the sequence of multiple linguistic prompts monotonically increase by one.

7. The method of claim 1 further comprising during said feedforward pass, initializing exactly one initial vector decomposition.

8. The method of claim 7 wherein said initializing is based on at least one selected from a group consisting of: a plurality of bias terms, a plurality of attention weights, and a portion of the output.

9. The method of claim 7 wherein:
the transformer model contains a sequence of transformer blocks that begins with a first transformer block that is adjacent to a second transformer block;
said initializing is based on the first transformer block and not the second transformer block.

10. The method of claim 9 wherein:
the first transformer block contains a block sequence of multiple transformer sublayers that begins with a first attention sublayer that is adjacent to a second transformer sublayer;
the model sequence of multiple transformer sublayers begins with the block sequence of multiple transformer sublayers;
said initializing is based on the first attention sublayer and not the second transformer sublayer.

11. The method of claim 10 wherein:
the first transformer block or the second transformer block contains a particular transformer sublayer that is not the first attention sublayer;
the method further comprises to the particular transformer sublayer, applying at least one selected from a group consisting of:
a) a decomposition propagation rule for attention sublayers,
b) a decomposition propagation rule for linear sublayers,
c) a decomposition propagation rule for nonlinear sublayers,
d) a decomposition propagation rule for sublayers that perform an operation selected from a group consisting of: vector concatenation, vector Hadamard product, normalization, and nonlinear activation.

12. The method of claim 7 wherein:
said initializing comprises generating a plurality of row vectors;
a count of row vectors in the plurality of row vectors does not exceed a count of lexical tokens in the linguistic prompt.

13. The method of claim 7 wherein:
said transferring comprises generating and transferring a plurality of row vectors;
a count of row vectors in the plurality of row vectors does not exceed a count of lexical tokens in the linguistic prompt.

14. The method of claim 1 further comprising performing the feedforward pass without calculating a gradient.

15. One or more non-transitory computer-readable media storing instructions that, when executed by one or more processors, cause:
during a feedforward pass in a transformer model that contains a model sequence of multiple transformer sublayers:
a) transferring, to a last transformer sublayer in the transformer model, from a previous transformer sublayer that is adjacent to the last transformer sublayer, exactly one previous vector decomposition, and
b) generating, from the exactly one previous vector decomposition and an input of the last transformer sublayer, exactly one last vector decomposition; and
generating, from the exactly one last vector decomposition, a local explanation for why the transformer model inferentially generated an output from a linguistic prompt.

16. The one or more non-transitory computer-readable media of claim 15 wherein the transformer model is at least one selected from a group consisting of:
a transformer model that does not contain an encoder and
a transformer model that contains a decoder that contains at least part of the model sequence of multiple transformer sublayers.

17. The one or more non-transitory computer-readable media of claim 15 wherein the instructions further cause generating the linguistic prompt by concatenating an original linguistic prompt and a portion of the output.

18. The one or more non-transitory computer-readable media of claim 15 wherein said
generating the local explanation comprises generating and truncating a plurality of row vectors.

19. The one or more non-transitory computer-readable media of claim 15 wherein the output is selected from a group consisting of:
an output sequence of lexical tokens and
exactly one lexical token in an output sequence of lexical tokens.

20. The one or more non-transitory computer-readable media of claim 15 wherein the instructions further cause during said feedforward pass, initializing exactly one initial vector decomposition.
